(19) United States
(12) Patent Application Publication
(10) Pub. No.: US 2023/0397291 A1
(43) Pub. Date: Dec. 7, 2023

(54) METHOD FOR SMALL DATA TRANSMISSION

(71) Applicant: ZTE CORPORATION, Shenzhen (CN)

(72) Inventors: He HUANG, Shenzhen (CN); Zijiang MA, Shenzhen (CN); Wenting LI, Shenzhen (CN)

(73) Assignee: ZTE CORPORATION, Shenzhen (CN)

(21) Appl. No.: 18/330,430

(22) Filed: Jun. 7, 2023

Related U.S. Application Data
(63) Continuation of application No. PCT/CN2021/073683, filed on Jan. 26, 2021.

(51) Int. Cl. H04W 76/27; H04L 49/90

(52) U.S. Cl. CPC H04W 76/27; H04L 49/90

(57) ABSTRACT

A wireless communication method for use in a first wireless network node is disclosed. The wireless communication method comprises receiving, from a wireless terminal, a radio resource control resume message and uplink, UL, data associated with a small data transmission, transmitting, to a second wireless network node, the radio resource control resume message, and determining whether to buffer the UL data based on an event associated with a first indicator.

This application is a continuation of PCT/CN2021/073683, filed Jan. 26, 2021, the content of which is incorporated herein by reference in its entirety.

### TECHNICAL FIELD

This document is directed generally to wireless communications, and in particular to small data transmissions.

### BACKGROUND

The new radio (NR) supports a radio resource control (RRC) inactive state (i.e., RRC_INACTIVE state) and user equipments (UEs) having infrequent (e.g., periodic and/or non-periodic) data transmissions are generally maintained by the network in the RRC_INACTIVE state.

### SUMMARY

Until Rel-16, the RRC_INACTIVE state does not support data transmissions. Hence, the UE needs to resume a connection (i.e., move to an RRC_CONNECTED state) for any downlink (DL) (mobile terminated (MT)) or UL (mobile oriented (MO)) data. Procedures of connection setup and subsequent release to the inactive state are required for each data transmission no matter how small and infrequent the data packets are, resulting in unnecessary power consumption and signaling overhead.

The signaling overhead generated by the UEs in the inactive state for the small data packets is a general problem and becomes a critical issue for not only network performance and efficiency but also the UE battery performance when more and more UEs are introduced in the NR system. In general, any device that has intermittent small data packets in the inactive state benefits from enabling small data transmission (SDT) in the inactive state. Thus, how to realize the SDT becomes an issue to be discussed.

This document relates to methods, systems, and devices for the small data transmissions, and in particular to methods, systems, and devices for small data transmissions using configured grant.

The present disclosure relates to a wireless communication method for use in a first wireless network node. The wireless communication method comprises:
receiving, from a wireless terminal, a radio resource control resume message and uplink, UL, data associated with a small data transmission,
transmitting, to a second wireless network node, the radio resource control resume message, and
determining whether to buffer the UL data based on an event associated with a first indicator.

Various embodiments may preferably implement the following features:

Preferably or in some embodiments, determining whether to buffer the UL data based on the event associated with the first indicator comprises:
receiving, from the second wireless network node, the first indicator,
buffering the received UL data based on the first indicator, and
handling the buffered UL data based on an event associated with a second indicator from the second wireless network.

Preferably or in some embodiments, the first indicator indicates buffering the UL data.

Preferably or in some embodiments, handling the buffered UL data based on the event associated with the second indicator from the second wireless network comprises:
receiving, from the second wireless network node, the second indicator, and
transmitting, to a user plane function, the buffered UL data based on the second indicator.

Preferably or in some embodiments, the second indicator is received within a period after at least one of receiving the UL data from the wireless terminal, buffering the UL data or transmitting the radio resource control resume message to the second wireless network node.

Preferably or in some embodiments, the wireless communication method further comprises discarding the buffered UL data when the second indicator associated with transmitting the buffered UL data to a user plane function is not received within a period after at least one of receiving the UL data from the wireless terminal, buffering the UL data or after transmitting the radio resource control resume message to the second wireless network node.

Preferably or in some embodiments, buffering the received UL data based on the first indicator comprises:
buffering the received UL data associated with the first indicator.

Preferably or in some embodiments, the wireless communication method further comprises transmitting, to a user plane function, the UL data unassociated with the first indictor in response to receiving the UL data unassociated with the first indictor.

Preferably or in some embodiments, determining whether to buffer the UL data based on the event associated with the first indicator comprises:
transmitting, to a user plane function, the received UL data in response to receiving the UL data when the first indicator is not received or the first indicator indicating not buffering the UL data is received.

Preferably or in some embodiments, transmitting, to the user plane function, the received UL data in response to receiving the UL data comprises:
transmitting, to the user plane function, the received UL data associated with the first indicator in response to receiving the UL data.

Preferably or in some embodiments, the first indicator is configured per wireless terminal, per dedicated radio bearer, per protocol data unit session or per quality of service flow.

Preferably or in some embodiments, the first wireless network node is a distributed unit of a base station and the second wireless network node is a centralized unit of the base station.

Preferably or in some embodiments, the small data transmission is associated with a configured grant.

The present disclosure relates to a wireless communication method for use in a second wireless network node. The wireless communication method comprises:
transmitting, to a third wireless network node, a first indicator associated with buffering uplink, UL, data of a small data transmission,
receiving, from a first wireless network node, a radio resource control resume message of a wireless terminal, and
determining whether to transmit a second indicator to the third wireless network node based on a result of authenticating the wireless terminal based on the radio resource control resume message,
wherein the second indicator is associated with transmitting the buffered UL data to a user plane function.

Various embodiments may preferably implement the following features:

Preferably or in some embodiments, the first indicator indicates whether to buffer the UL data.

Preferably or in some embodiments, determining whether to transmit the second indicator to the third wireless network node based on the result of authenticating the wireless terminal based on the radio resource control resume message comprises:
transmitting, to the third wireless network node, the second indicator when successfully authenticating the wireless terminal, or
not transmitting, to the third wireless network node, the second indicator when unsuccessfully authenticating the wireless terminal.

Preferably or in some embodiments, the first indicator is configured per wireless terminal, per dedicated radio bearer, per protocol data unit session or per quality of service flow.

Preferably or in some embodiments, the first wireless network node is the third wireless network node and is a distributed unit of a base station and the second wireless network node is a centralized unit of the base station.

Preferably or in some embodiments, the first wireless network node is a distributed unit of a base station, the second wireless network node is a control plane of a centralized unit of the base station and the third wireless network node is a user plane of the centralized unit of the base station.

Preferably or in some embodiments, the small data transmission is associated with a configured grant.

The present disclosure relates to a wireless communication method for use in a third wireless network node. The wireless communication method comprises:
receiving, from a first wireless network node, uplink, UL, data for a small data transmission of a wireless terminal, and
determining whether to buffer the UL data based on an event associated with a first indicator from a second wireless network node.

Various embodiments may preferably implement the following features:

Preferably or in some embodiments, determining whether to buffer the UL data based on the event associated with the first indicator comprises:
receiving, from the second wireless network node, the first indicator,
buffering the received UL data based on the first indicator, and
handling the buffered UL data based on an event associated with a second indicator from the second wireless network.

Preferably or in some embodiments, the first indicator indicates buffering the UL data.

Preferably or in some embodiments, handling the buffered UL data based on the event associated with the second indicator from the second wireless network comprises:
receiving, from the second wireless network node, the second indicator, and
transmitting, to a user plane function, the buffered UL data based on the second indicator.

Preferably or in some embodiments, the second indicator is received within a period after receiving the UL data from the first wireless network node and/or after buffering the UL data.

Preferably or in some embodiments, the wireless communication method further comprises discarding the buffered UL data when the second indicator associated with transmitting the buffered UL data to a user plane function is not received within a period after receiving the UL data from the first wireless network node and/or after buffering the UL data.

Preferably or in some embodiments, buffering the received UL data based on the first indicator comprises:
buffering the received UL data associated with the first indicator.

Preferably or in some embodiments, the wireless communication method further comprises transmitting, to a user plane function, the UL data unassociated with the first indictor in response to receiving the UL data unassociated with the first indictor.

Preferably or in some embodiments, determining whether to buffer the UL data based on the event associated with the first indicator comprises:
transmitting, to a user plane function, the received UL data in response to receiving the UL data when the first indicator is not received or the first indicator indicating not buffering the UL data is received.

Preferably or in some embodiments, transmitting, to the user plane function, the received UL data in response to receiving the UL data comprises:
transmitting, to the user plane function, the received UL data associated with the first indicator in response to receiving the UL data.

Preferably or in some embodiments, the first indicator is configured per wireless terminal, per dedicated radio bearer, per protocol data unit session or per quality of service flow.

Preferably or in some embodiments, the first wireless network node is a distributed unit of a base station, the second wireless network node is a control plane of a centralized unit of the base station and the third wireless network node is a user plane of the centralized unit of the base station.

Preferably or in some embodiments, the small data transmission is associated with a configured grant.

The present disclosure relates to a first wireless network node. The first wireless network node comprises:
a communication unit, configured to:
receive, from a wireless terminal, a radio resource control resume message and uplink, UL, data associated with a small data transmission, and
transmit, to a second wireless network node, the radio resource control resume message, and
a processor configured to determine whether to buffer the UL data based on an event associated with a first indicator.

Various embodiments may preferably implement the following feature:

Preferably or in some embodiments, the processor is further configured to perform any of aforementioned wireless communication methods.

The present disclosure relates to a second wireless network node. The second wireless network node comprises:
a communication unit, configured to:
transmit, to a third wireless network node, a first indicator associated with buffering uplink, UL, data of a small data transmission,
receive, from a first wireless network node, a radio resource control resume message of a wireless terminal
a processor configured to determine whether to transmit a second indicator to the third wireless network node based on a result of authenticating the wireless terminal based on the radio resource control resume message,
wherein the second indicator is associated with transmitting the buffered UL data to a user plane function.

Various embodiments may preferably implement the following feature:

Preferably or in some embodiments, the processor is further configured to perform any of aforementioned wireless communication methods.

The present disclosure relates to a third wireless network node. The third wireless network node comprises:
a communication unit, configured to receive, from a first wireless network node, uplink, UL, data for a small data transmission of a wireless terminal
a processor configured to determine whether to buffer the UL data based on an event associated with a first indicator from a second wireless network node.

Various embodiments may preferably implement the following feature:

Preferably or in some embodiments, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF DRAWINGS

FIG. 1 shows a schematic diagram of a method according to an embodiment of the present disclosure.

FIG. 2 shows a schematic diagram of a method according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIG. 5 shows a flowchart of a method according to an embodiment of the present disclosure.

FIG. 6 shows a flowchart of a method according to an embodiment of the present disclosure.

FIG. 7 shows a flowchart of a method according to an embodiment of the present disclosure.

In the present disclosure, the inactive state may be equal to RRC inactive state and/or RRC_INACTIVE.

### DETAILED DESCRIPTION

In the present disclosure, a small data transmission (SDT) may be a data transmission performed for (or by) the UE in an inactive state (e.g., radio resource control (RRC) inactive state (RRC_INACTIVE)) or a connection management (CM) connected (CM-CONNECTED) state. The SDT may be performed in a random access procedure (e.g., 2 step random access procedure, 4 step random access procedure) or a (RRC) resume procedure or a configured grant transmission (e.g., configured grant type-1 (CG type-1) transmission). In an embodiment, characteristics of the SDT may comprise at least one of:
a(n) (application) packet size of 100 bytes for uplink (UL) and 100 bytes for downlink (DL);
latency of 5 seconds to 30 minutes; 1 hour for no mobility scenario;
frequency of every minute and up to monthly.

Note that the latency of the SDT is a duration from the packet of the SDT arriving at the buffer until the packet is completely transmitted. According to an embodiment, the small data transmission is further specified in 3GPP TR 25.705 V13.0.0.

In the present disclosure, the data transmitted in the SDT may be named “small data”, “user data”, “UL data”, “UL small data” or “UL user data”.

The key enablers for the SDT in the NR (e.g., in the inactive state, the 2-step random access procedure, the 4-step RACH procedure and the CG type-1 transmission) have already been specified as a part of Rel-15 and Rel-16. The present disclosure provides a method for enabling the SDT for the NR based on the following building blocks.

For the RRC_INACTIVE state:
UL small data transmissions for RACH-based (random access channel based) schemes (e.g., 2-step and 4-step random access procedure):
1) general procedure to enable UP data transmission for small data packets from the inactive state;
2) enable flexible payload sizes larger than the Rel-16 common control channel (CCCH) message size that is possible currently for the inactive state for message-A (MSGA) in the 2-step random access procedure and/or message-3 (MSG3) in the 4-step random access procedure to support user plane (UP) data transmissions in the uplink (UL) direction. Note that actual payload size may be determined based on network configuration;
3) context fetch and data forwarding (with and without anchor relocation) in the inactive state for RACH-based solutions.
Transmission of UL data on pre-configured PUSCH resources (i.e., reusing the configured grant type 1)—when TA is valid:
1) general procedure for small data transmission over configured grant type 1 resources from INACTIVE state;
2) configuration of the configured grant type 1 resources for small data transmission in UL for INACTIVE state.
Specify RRM core requirements for small data transmission in RRC_INACTIVE, if needed.

For the configuration of CG type 1 resources valid in the inactive state may be configured to the UE before the UE enters the inactive state, and the configured CG type 1 resources are only valid in a cell where the UE enters the inactive state.

In addition, it is agreed that stored “configuration” in the UE context is used for the radio link control (RLC) bearer configuration for any SDT mechanism (e.g., random access procedure or CG type transmission). The CG type transmission uses pre-configured physical UL shared channel (PUSCH) resources to transmit the UL small data.

Regarding the SDT mechanism on RRC/non-RRC based approaches and RACH requirements for the radio bearer configuration for SDT mechanism in case of a centralized unit/distributed unit (CU/DU) split architecture, the following legacy network operations considering the NR CU/DU split architecture may be relevant for the new SDT mechanism for the UE in the inactive state:
the UE and a CU-control plane (CU-CP) store the UE context when UE moves into the inactive state;
when the UE moves into the inactive state, the DU releases the stored UE context as well as the corresponding tunnels established between the DU and CU-user plane (UP);
the CU-UP retains the UE context in a suspended state when the UE is in the inactive state.

In the present disclosure, a UL data transmission method may be named CG based SDT method.

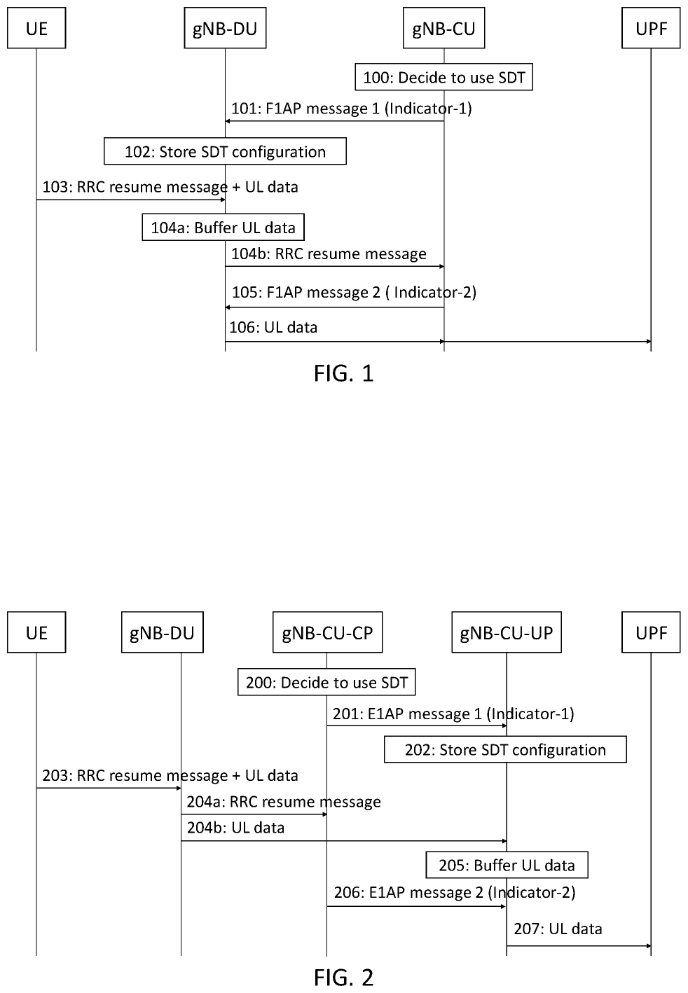

FIG. 1 shows a schematic diagram of a method according to an embodiment of the present disclosure. In FIG. 1, the gNB-DU (i.e., DU of the gNB) buffers the UL data of the SDT until receiving notification.

More specifically, the gNB-CU (i.e., CU of the gNB) decides to command a UE to enter the RRC inactive state and allows the UE to use CG resources to transmit user data of SDT DRB (i.e., SDT type DRB) during the period of the UE in the RRC inactive state. Each SDT DRB is identified by a DRB identifier (IE) and each SDT DRB can be distinguished from other SDT DRB by the DRB ID (step 100). In the present disclosure, the UL data is SDT type UL data.

In step 101, the gNB-CU sends an F1AP message 1 comprising indicator information (i.e., indicator-1) to the gNB-DU, to indicate a configuration of the SDT for the UE. The indicator-1 is used to indicate the gNB-DU that when the gNB-DU receives uplink user data, the gNB-DU shall buffer the UL data and not transmit the UL data to the gNB-CU until receiving another indicator (i.e., indicator-2) from the gNB-CU. In an embodiment of the gNB-CU being split into gNB-CU-CP (i.e., the CU-CP of the gNB) and gNB-CU-UP (i.e., the CU-UP of the gNB), the indicator-1 is sent by the gNB-CU-CP.

In an embodiment, the indicator-1 may be configured per UE, per DRB or per PDU session. When the indicator-1 is configured per UE/per DRB/per PDU session/per QoS flow, all UL data belonging to (e.g., associated with, related to) the UE/DRB/PDU session/QoS flow corresponding to the indicator-1 shall be buffered by the gNB-DU and cannot be transmitted to the gNB-CU until the gNB-DU receives another indicator (i.e., indicator-2). In an embodiment, when the indicator-1 exists (i.e., the gNB-DU receives and/or stores the indicator-1), the corresponding UL data shall be buffered and not be immediately transmitted. In addition, when the indicator-1 does not exist (i.e., the gNB-DU does not receive the indicator-1), the corresponding UL data may be transmitted immediately (after being received by the gNB-DU). In other words, if the UL data is configured with the indicator-1, the UL data shall be buffered; otherwise the UL data may be transmitted immediately.

In an embodiment, a value of the indicator-1 may be set to different values, e.g., corresponding to “buffer” and “not buffer”. In this embodiment, when the UL data is configured with the indicator-1, whether the UL data shall be buffered or immediately transmitted is determined according to the value of the indicator-1.

In an embodiment of the indicator-1 being configured per DRB or per QoS flow, the indicator-1 associated with all of DRBs/all QoS flows belonging to the same PDU Session shall have the same value if the UL data shall be buffered or immediately transmitted is determined according to the value of the indicator-1. As an alternative, the indicator-1 shall be configured or shall not be configured to all of the DRBs/all QoS flows belonging to the same PDU session together, if the UL data shall be buffered or immediately transmitted is determined according to the existence of the indicator-1.

In an embodiment, another indicator (i.e., indicator-2) is sent from the gNB-CU to the gNB-DU for indicating that the gNB-DU is allowed to transmit the UL data.

In this embodiment, the gNB-CU sends the indicator-1 to the gNB-DU via the an F1AP message 1 including the indicator-1. For example, the F1AP message 1 may be a UE context release command message.

In an embodiment, the method of sending the indicator-2 comprises that the gNB-CU sends a F1AP message 2 to the gNB-DU, wherein the F1AP message 2 includes the indicator-2. For example, this F1AP message 2 may be a UE CONTEXT MODIFICATION REQUEST message.

In step 102, the gNB-DU stores the SDT configuration (i.e., indicator-1).

In step 103, the gNB-DU receives an RRC Resume message and UL data from the UE.

In steps 104a and 104b, the gNB-DU sends an F1AP message including the RRC Resume message and judges (determines), based on the stored indicator-1, that the received UL data can be transmitted to the gNB-DU directly or that the received UL data shall be buffered. In this embodiment, because receiving the indicator-1 and/or the indicator-1 indicates buffering the UL data, the gNB-DU buffers the UL data, e.g., until further notice (i.e., indicator-2) from the gNB-CU. In an embodiment of the indicator-1 is not received or the indicator-1 indicates not buffering the UL data is received, the gNB-DU directly (e.g., immediately) transmits the UL data to the gNB-CU after (e.g., in response to) receiving the UL data.

In steps 105 and 106, the gNB-DU receives a F1AP message 2 including the indicator-2, e.g., within a predetermined period after receiving the UL data from the UE, and/or buffering the UL data and/or transmitting the RRC resume message to the gNB-CU. Based on the indicator-2, the gNB-DU transmits the buffered UL data to the gNB-CU. If the indicator-2 is not received (within the predetermined period after receiving the UL data from the UE and/or buffering the UL data and/or transmitting the RRC resume message to the gNB-CU), the gNB-DU discards the buffered UL data.

FIG. 2 shows a schematic diagram of a method according to an embodiment of the present disclosure. In FIG. 2, the gNB-CU-UP buffers the UL data until receiving a notification.

In step 200, the gNB-CU-CP decides to command a UE to enter into the RRC inactive state and allows the UE to use the CG resources to transmit UL data of SDT DRB (i.e., SDT type DRB) during the period of the UE staying in the RRC inactive state.

In an embodiment, each SDT DRB is identified by a DRB ID. Thus, each SDT DRB can be distinguished from other SDT DRBs by the DRB ID.

In step 201, the gNB-CU-CP sends an E1AP message including indicator information (i.e., indicator-1) to the gNB-CU-UP, wherein the indicator-1 is used to indicate the gNB-CU-UP that when the gNB-CU-UP receives the UL data, the gNB-CU-UP shall buffer the UL data and not transmit the UL data to the 5GC (i.e., UPF) until receiving another indicator (i.e., indicator-2).

In an embodiment, the indicator-1 may be configured for per UE, per DRB, per PDU session or per QoS flow. When indicator-1 is configured per UE/per DRB/per PDU session/per QoS flow, all UL data belonged to corresponding UE/DRB/PDU session/QoS flow shall be buffered and cannot be transmitted to the 5GC until the gNB-CU-UP receives another indicator (i.e., indicator-2). In this embodiment, when indicator-1 exists (e.g., is configured), the corresponding UL data shall be buffered and not be transmitted. When the indicator-1 does not exist (e.g., is not configured), the corresponding UL data may be transmitted immediately (after being received). In other words, if the UL data is configured with the indicator-1, the UL data shall be buffered; and if the UL data is not configured with the indicator-1, the UL data may be transmitted immediately after being received.

In an embodiment, the value of indicator-1 can be set to different values, e.g., “buffer/pending” and “not buffer/not pending”. In this embodiment, when receiving the UL data configured with the indicator-1, the gNB-CU-UP shall buffer or immediately transmit the UL data according to the value of the configured (stored) indicator-1.

In an embodiment of the indicator-1 configured per DRB or per QoS flow, the indicator-1 associated with all of DRBs/all QoS flows belonging to the same PDU session shall have the same value if the UL data shall be buffered or immediately transmitted is determined according to the value of the indicator-1. As an alternative, the indicator-1 shall be configured or shall not be configured to all of the DRBs/all QoS flows belonging to the same PDU session together if the UL data shall be buffered or immediately transmitted is determined according to the existence of the indicator-1.

In an embodiment, the indicator-2 is sent from the gNB-CU-CP to the gNB-CU-UP and is used to indicate the gNB-CU-UP that the gNB-CU-UP is allowed to transmit the UL data.

In an embodiment, the method of sending the indicator-1 may comprise that the gNB-CU-CP sends an E1AP message (e.g., message-3) to the gNB-CU-UP, wherein the E1AP message includes the indicator-1. For example, this E1AP message may be a BEARER CONTEXT MODIFICATION REQUEST message.

In an embodiment, the method of sending the indicator-2 may comprise that the gNB-CU sends an E1AP message (named message-4) to the gNB-CU-UP, wherein this E1AP message includes the indicator-2. For example, the E1AP message may be a BEARER CONTEXT MODIFICATION REQUEST message.

In step 202, the gNB-CU-CP stores the indicator-1 (information).

In step 203, the gNB-DU receives an RRC resume message and UL data from the UE.

In steps 204a and 204b, the gNB-DU sends an E1AP message including the RRC resume message to the gNB-CU-CP and sends the UL data to the gNB-CU-UP.

In step 205, the gNB-CU-UP receives the UL data and judges that the received UL data can be transmitted to the 5GC directly or shall be buffered according to the stored indicator-1. In this embodiment, the gNB-CU-UP buffers the UL data because receiving the indicator-1 and/or the value of the indicator-1 indicates buffering the UL data. In an embodiment of not receiving the indicator-1 or receiving the indicator-1 whose value indicates not buffering the UL data, the gNB-CU-UP transmits the UL data to the UPF immediately after (e.g., in response to) receiving the UL data.

In step 206, after receiving the RRC resume message, the gNB-CU-CP sends an E1AP message 2 including the indicator-2 to the gNB-CU-UP when the associated UE is successfully verified.

In step 207, if receiving the E1AP message 2 including the indicator-2 within a predetermined period after receiving the UL data and/or buffering the UL data, the gNB-CU-UP transmits the buffered UL data to the 5GC; otherwise, the gNB-CU-UP discards the UL data.

In the present disclosure, the UL data of the SDT (type) may not be transmitted to the 5GC (e.g., UPF) before the UE associated with the UL data is successfully verified.

In an embodiment of the CU/DU split gNB, the UL data may be buffered by the gNB-DU or gNB-CU. In the embodiment of the UL data being buffered by the gNB-CU, the UL data is buffered by gNB-CU-UP in the case of gNB-CU-CP/gNB-CU-UP split gNB-CU.

Note that, the UE is verified (e.g., authenticated) by the gNB-CU or the gNB-CU-CP.

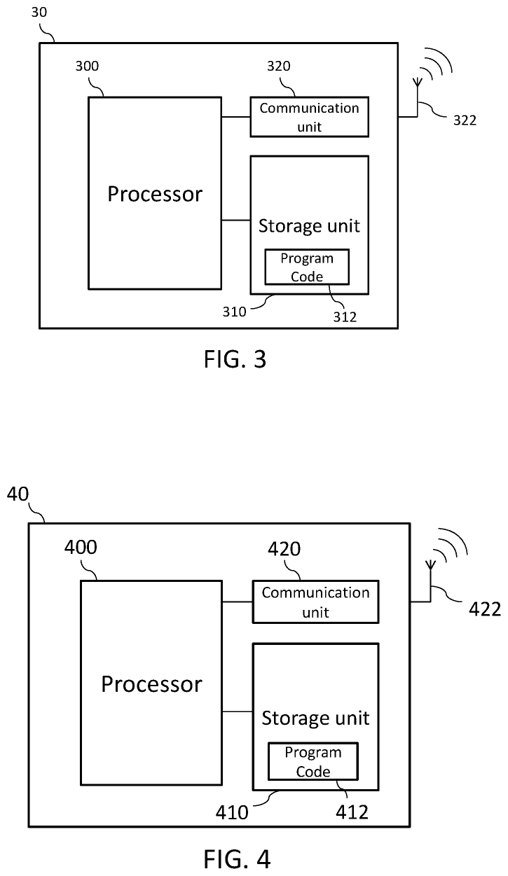

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g., a base station).

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU), a gNB-CU-CP (control plane), a gNB-CU-UP (user plane), a data network, a core network or a Radio Network Controller (RNC), and is not limited herein. In addition, the wireless network node 40 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

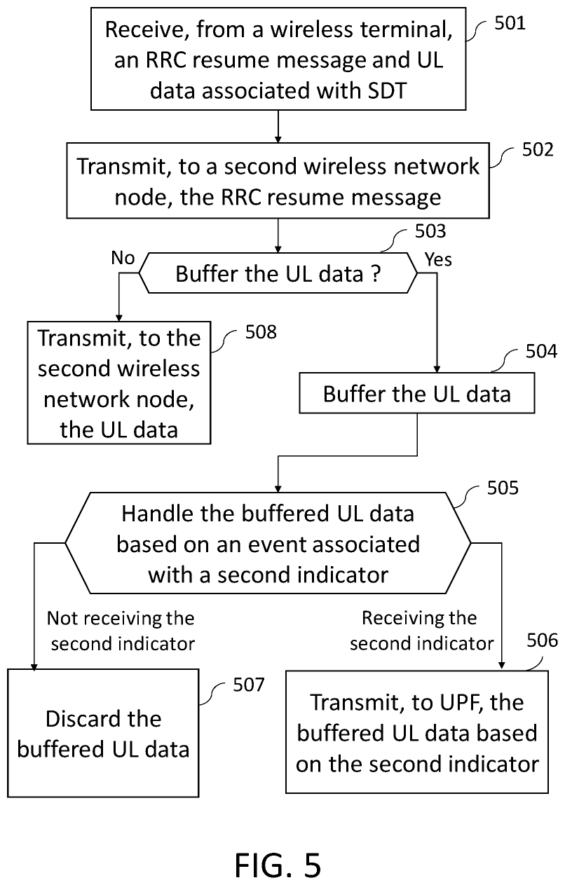

FIG. 5 shows a schematic flowchart of a method according to an embodiment of the present disclosure. The method shown in FIG. 5 may be used in a first wireless network node (e.g., gNB-DU). In FIG. 5, the first wireless network node receives an RRC resume message and UL data from a wireless terminal (e.g., UE) in the inactive state. That is, the RRC resume message and/or the UL data is for (e.g., associated with) the SDT (step 501). Next, the first wireless network node transmits the RRC resume message to a second wireless network node (e.g., gNB-CU or gNB-CU-CP) (step 502) and determines whether to buffer the UL data based on an event associated with a first indicator (e.g., indicator-1) (step 503).

In an embodiment, the event associated with the first indicator comprises receiving the first indicator and/or receiving the first indicator indicating buffering the UL data from the second wireless terminal (e.g., gNB-CU-CP). In this embodiment, the first wireless network node determines buffering the UL data and handles the buffered UL data based on an event associated with a second indicator (e.g., indicator-2) (steps 504 and 505).

In an embodiment, the first indicator may be configured per wireless terminal, per DRB, per PDU session or per QoS flow. Under such conditions, the first wireless network node buffers the UL data associated with the first indicator (i.e., corresponding wireless terminal, DRB, PDU session or QoS flow). In addition, the first wireless network node may transmit the UL data unassociated with the first indicator to the core network (e.g., UPF or 5GC) immediately after (e.g., directly after or in response to) receiving the UL data unassociated with the first indicator.

In an embodiment, the event associated with the second indicator comprises receiving the second indicator from the second wireless network node. In this embodiment, the first wireless network node transmits the buffered UL data to the core network (e.g., UPF or 5GC). Note that, the second indicator may be received within a predetermined period after at least one of receiving the UL data, buffering the UL data or transmitting the RRC resume message (step 506).

In an embodiment, the event associated with the second indicator comprises not receiving the second indicator from the second wireless network node. In this embodiment, the first wireless network node discards (e.g., drops) the buffered UL data. Note that the event associated with the second indicator in this embodiment may refer to the second indicator not being received within the predetermined period after at least one of receiving the UL data, buffering the UL data or transmitting the RRC resume message (step 507).

In an embodiment, the event associated with the first indicator comprises not receiving the first indicator or receiving the first indicator indicating not buffering the UL data. In this embodiment, the first wireless network node transmits the received UL data immediately after (e.g., directly or in response to) receiving the UL data (step 508).

Note that the SDT in FIG. 5 may refer to CG SDT. That is, the SDT is associated with a CG or uses CG resources.

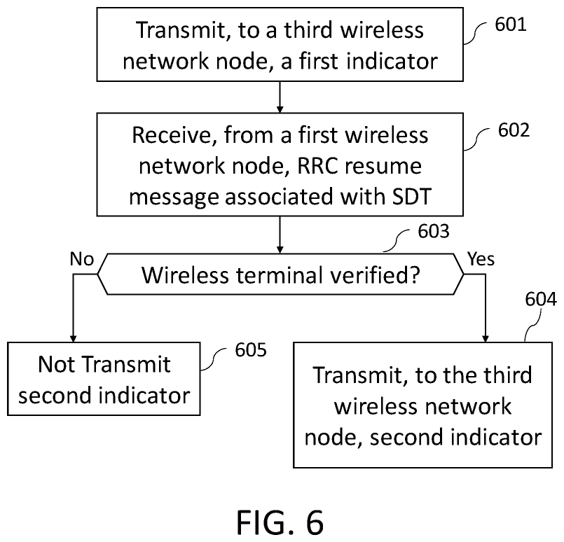

FIG. 6 shows a schematic flowchart of a method according to an embodiment of the present disclosure. The method shown in FIG. 6 may be used in a second wireless network node (e.g., gNB-CU or gNB-CU-CP). In FIG. 6, the second wireless network node transmits a first indicator (e.g., indicator-1) to a third wireless network node (gNB-DU or gNB-CU-UP) (step 601). The first indicator is associated with buffering UL data for a SDT. For example, the first indicator indicates whether to buffer UL data. In the following, it is assumed that the first indicator indicates buffering the UL data if the first indicator indicates whether to buffer UL data.

The first indicator may be configured per wireless terminal (e.g., UE), per DRB, per PDU session, or per QoS flow. The UL data buffered by the third wireless network node may be associated with the first indicator (i.e., corresponding wireless terminal, DRB, PDU session or QoS flow).

In step 602, the second wireless network node receives a RRC resume message from a first wireless network node (e.g., gNB-DU). The RRC resume message is associated with the wireless terminal for which the first indicator is configured. In addition, the RRC resume message is associated with the SDT. That is, the wireless terminal is in the inactive state.

Based on the RRC resume message, the second wireless network node verifies or authenticates the wireless terminal. According to the result of verifying or authenticating the wireless terminal, the second wireless network node determines whether to transmit a second indicator associated with transmitting the buffered UL data to the UPF (e.g., 5GC) to the third wireless network node. If the wireless terminal is successfully verified or authenticated, the second wireless network node transmits the second indicator to the third wireless network node; if the wireless terminal is unsuccessfully verified or authenticated (i.e., verifying or authenticating the wireless terminal fails), the second wireless network node does not transmit the second indicator (steps 603, 604, 605).

In an embodiment of FIG. 6, the first wireless network node is the third wireless network node and is a distributed unit of a base station (e.g., gNB-DU) and the second wireless network node is a centralized unit of the base station (e.g., gNB-CU).

In an embodiment of FIG. 6, the first wireless network node is a distributed unit of a base station (e.g., gNB-DU), the second wireless network node is a control plane of a centralized unit of the base station (e.g., gNB-CU-CP) and the third wireless network node is user plane of the centralized unit of the base station (e.g., gNB-CU-UP).

Note that the SDT in FIG. 6 may refer to CG SDT. That is, the SDT is associated with a CG or uses CG resources.

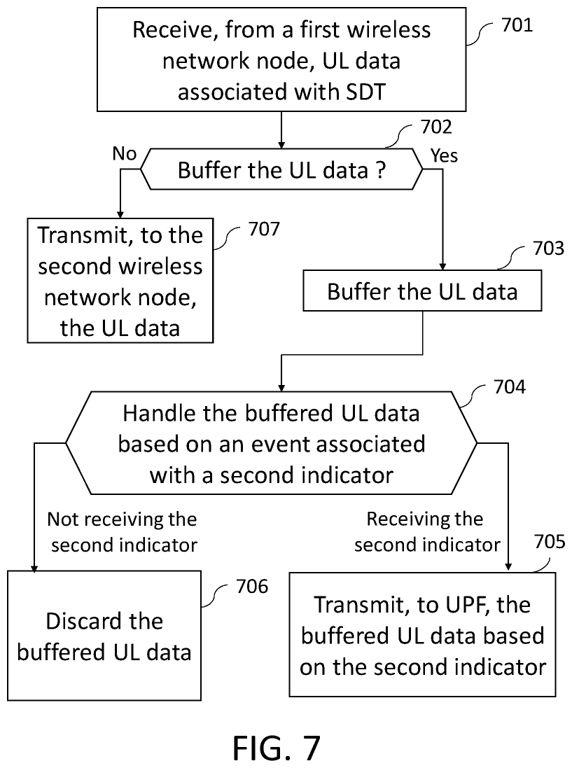

FIG. 7 shows a schematic flowchart of a method according to an embodiment of the present disclosure. The method shown in FIG. 7 may be used in a third wireless network node (e.g., gNB-CU-UP).

In FIG. 7, the third wireless network node receives UL data of a wireless terminal (e.g., UE) from a first wireless network node (e.g., gNB-DU). The UL data is for (e.g., associated with) the SDT (step 701). Next, the third wireless network node determines whether to buffer the UL data based on an event associated with a first indicator (e.g., indicator-1) (step 702). The first indicator may be received from a second wireless network node (e.g., gNB-CU-CP) and/or stored in the third wireless network node.

In an embodiment, the event associated with the first indicator comprises receiving the first indicator and/or receiving the first indicator indicating buffering the UL data from the second wireless terminal. In this embodiment, the first wireless network node determines buffering the UL data and handles the buffered UL data based on an event associated with a second indicator (e.g., indicator-2) (steps 703 and 704).

In an embodiment, the first indicator may be configured per wireless terminal, per DRB, per PDU session or per QoS flow. Under such conditions, the third wireless network node buffers the UL data associated with the first indicator (i.e., corresponding wireless terminal, DRB, PDU session or QoS flow). In addition, the third wireless network node may transmit the UL data unassociated with the first indicator to the core network (e.g., UPF or 5GC) immediately after (e.g., directly after or in response to) receiving the UL data unassociated with the first indicator.

In an embodiment, the event associated with the second indicator comprises receiving the second indicator from the second wireless network node. In this embodiment, the third wireless network node transmits the buffered UL data to the core network (e.g., UPF or 5GC). Note that the second indicator may be received within a predetermined period after at least one of receiving the UL data or buffering the UL data (step 705).

In an embodiment, the event associated with the second indicator comprises not receiving the second indicator from the second wireless network node. In this embodiment, the third wireless network node discards (e.g., drops) the buffered UL data. Note that the event associated with the second indicator in this embodiment may refer to the second indicator not being received within the predetermined period after at least one of receiving the UL data or buffering the UL data (step 706).

In an embodiment, the event associated with the first indicator comprises not receiving the first indicator or receiving the first indicator indicating not buffering the UL data. In this embodiment, the third wireless network node transmits the received UL data immediately after (e.g., directly after or in response to) receiving the UL data (step 707).

Note that, the SDT in FIG. 7 may refer to CG SDT. That is, the SDT is associated with a CG or uses CG resources.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein but is to be accorded the widest scope consistent with the novel features and principles disclosed herein, as recited in the claims below.

1. A wireless communication method for use in a second wireless network node, the method comprising:
transmitting, to a third wireless network node, a first indicator associated with buffering uplink (UL) data of a small data transmission,
receiving, from a first wireless network node, a radio resource control resume message of a wireless terminal, and
determining whether to transmit a second indicator to the third wireless network node based on a result of authenticating the wireless terminal based on the radio resource control resume message,
wherein the second indicator is associated with transmitting the buffered UL data to a user plane function.

2. The wireless communication method of claim 1, wherein the first indicator indicates whether to buffer the UL data.

3. The wireless communication method of claim 1, wherein determining whether to the second indicator to the third wireless network node based on the result of authenticating the wireless terminal based on the radio resource control resume message comprises:
transmitting, to the third wireless network node, the second indicator when successfully authenticating the wireless terminal, or
not transmitting, to the third wireless network node, the second indicator when unsuccessfully authenticating the wireless terminal.

4. The wireless communication method of claim 1, wherein the first wireless network node is a distributed unit of a base station, the second wireless network node is a control plane of a centralized unit of the base station, and the third wireless network node is a user plane of the centralized unit of the base station.

5. The wireless communication method of claim 1, wherein the small data transmission is associated with a configured grant.

6. A wireless communication method for use in a third wireless network node, the method comprising:
receiving, from a first wireless network node, uplink (UL) data for a small data transmission of a wireless terminal,
receiving, from a second wireless network node, a first indicator,
buffering the received UL data based on the first indicator, and
handling the buffered UL data based on an event associated with a second indicator from the second wireless network.

7. The wireless communication method of claim 6, wherein the first indicator indicates buffering the UL data.

8. The wireless communication method of claim 6, wherein handling the buffered UL data based on the event associated with the second indicator from the second wireless network comprises:
receiving, from the second wireless network node, the second indicator, and transmitting, to a user plane function, the buffered UL data based on the second indicator.

9. The wireless communication method of claim 6, wherein the first wireless network node is a distributed unit of a base station, the second wireless network node is a control plane of a centralized unit of the base station and the third wireless network node is a user plane of the centralized unit of the base station.

10. The wireless communication method of claim 6, wherein the small data transmission is associated with a configured grant.

11. A second wireless network node, comprising:
at least one processor, and
a memory, which is configured to store at least one program;
wherein the at least one program, when executed by the at least one processor, enables the at least one processor to:
transmit, to a third wireless network node, a first indicator associated with buffering uplink (UL) data of a small data transmission,
receive, from a first wireless network node, a radio resource control resume message of a wireless terminal, and
determine whether to transmit a second indicator to the third wireless network node based on a result of authenticating the wireless terminal based on the radio resource control resume message,
wherein the second indicator is associated with transmitting the buffered UL data to a user plane function.

12. The second wireless network node of claim 11, wherein the first indicator indicates whether to buffer the UL data.

13. The second wireless network node of claim 11, wherein the at least one processor determines whether to the second indicator to the third wireless network node based on the result of authenticating the wireless terminal based on the radio resource control resume message by:
transmitting, to the third wireless network node, the second indicator when successfully authenticating the wireless terminal, or
not transmitting, to the third wireless network node, the second indicator when unsuccessfully authenticating the wireless terminal.

14. The second wireless network node of claim 11, wherein the first wireless network node is a distributed unit of a base station, the second wireless network node is a control plane of a centralized unit of the base station and the third wireless network node is a user plane of the centralized unit of the base station.

15. The second wireless network node of claim 11, wherein the small data transmission is associated with a configured grant.

16. A third wireless network node, comprising:
at least one processor, and
a memory, which is configured to store at least one program;
wherein the at least one program, when executed by the at least one processor, enables the at least one processor to:
receive, from a first wireless network node, uplink (UL) data for a small data transmission of a wireless terminal,
receive, from a second wireless network node, a first indicator,
buffer the received UL data based on the first indicator, and
handle the buffered UL data based on an event associated with a second indicator from the second wireless network.

17. The third wireless network node of claim 16, wherein the first indicator indicates whether to buffer the UL data.

18. The third wireless network node of claim 16, wherein the at least one processor handles the buffered UL data based on the event associated with the second indicator from the second wireless network by:
receiving, from the second wireless network node, the second indicator, and transmitting, to a user plane function, the buffered UL data based on the second indicator.

19. The third wireless network node of claim 16, wherein the first wireless network node is a distributed unit of a base station, the second wireless network node is a control plane of a centralized unit of the base station and the third wireless network node is a user plane of the centralized unit of the base station.

20. The third wireless network node of claim 16, wherein the small data transmission is associated with a configured grant.
